(19) United States
(12) Patent Application Publication
(10) Pub. No.: US 2006/0267583 A1
(43) Pub. Date: Nov. 30, 2006

(54) Methods and devices for medium manipulation using quantum spin

(76) Inventor: John P. Keady, San Jose, CA (US)

Correspondence Address: Dr. John P. Keady, 8138 Crestridge Rd., Fairfax Station, VA, 22039, US

(21) Appl. No.: 11/399,860

(22) Filed: Apr. 7, 2006

Related U.S. Application Data
(60) Provisional application No. 60/668,947, filed on Apr. 7, 2005.

(51) Int. Cl. G01V 3/00

(52) U.S. Cl. 324/302; 324/307; 324/318

(57) ABSTRACT

At least one exemplary embodiment is directed to an apparatus using quantum spin to manipulate particles having spin to create a force or current, comprising: a magnetic gradient production apparatus, where the magnetic gradient production apparatus is configured to generate a magnetic field gradient in at least two directions, a first direction and a second direction; and a control circuit, where the control circuit controls the magnetic field gradient, wherein the magnetic field gradient produces a first force on the particles separating the particles into a pro-gradient spin portion and an anti-gradient spin portion, where at least one of the spin portions is spatially confined in the first direction.

field, where the direction of the force is the dot product of the spin state with the gradient magnetic field direction, where the magnitude of the force is expressed as:

$${F}_{z} \approx \pm \frac{1}{2} g {μ}_{B} \frac{\partial {B}_{z}}{\partial z} \qquad ( 1 )$$

where

$$\begin{matrix}{μ}_{B} = \frac{e \overline{h}}{2 {m}_{e}} \\ \approx 9.2740154 \times {10}^{- 24} J / T \\ \approx 5.7883826 \times {10}^{- 5} e V / T\end{matrix}$$

called the Bohr magneton, and ‘g’ the g-factor, which for an electron is approximately g=2.00232. Rearranging the equation for a mass and an associated acceleration, the formula can be expressed as for the electron:

$${ma}_{z} \approx \pm ( 9.2740154 \times {10}^{- 24} J / T ) \frac{\partial {B}_{z}}{\partial z} \qquad ( 2 )$$

where z is the initial streaming direction. Upon leaving the gradient magnetic field the two distinct streams can revert back to different spin orientation over time (e.g., via perturbations flipping the spin orientation), thus subsequent gradients can again split one of the two distinct streams into two more streams. The difference is that the second splitting is time dependent with a probability that changes with time. Thus, manipulation of the recently emerged two distinct streams is possible based upon their separated spin states. Note also that the force in equation (1) is dependent on the gradient of the magnetic field and not on the amplitude, thus very small systems with low amplitudes changes over small distances can have large gradient values.

Introduction to the Rabi Experiment and Refinement of the Force Equation

The Rabi apparatus is a more precise way of measuring the magnetic moments of neutrals. In the Stem-Gerlach experiment, the deflection of neutrals is small and the measurement non-precise. The Rabi method is based on the fact that the energy of neutrals will split into discemable energy levels in the presence of an external magnetic field gradient, like the Stem-Gerlach experiment. For example if a neutral in an external magnetic field gradient has two levels of energy then an applied electromagnetic wave of the correct frequency can cause a transfer of energy states (a spin flip). If the frequency of the light does not have the desired frequency the transfer probability (spin flip) is very low. The frequency of transition of spin in a magnetic field gradient is related to the resonance frequency defined by equation 3. ‘B’ is the external magnetic induction, ‘q’ is the charge state, ‘m’ is the mass of the particle and ‘g’ is called the ‘g factor.’ Note that the quantity on the right side of the equation before the magnetic induction is the ratio of the magnetic moment to the angular momentum. ‘q’ is the charge of an electron and ‘m’ is an electrons mass (see Feynman, A-11, Eqn 34.27).

$${ω}_{r} = g \frac{q}{2 m} B \qquad ( 3 )$$

FIG. 9 illustrates the Rabi apparatus. It consists of three magnet systems (two gradient magnetic section and a central uniform magnetic section). The beam of neutrals travel through each system to a detector at the end which measures a current. The first magnetic section 910 contains a positive vertical gradient in the external magnetic field, the second magnetic section 920 contains a uniform field, and the third magnetic system 930 contains a negative vertical gradient in the magnetic field. In the first magnet region the neutral beams are split into two paths (for spin ½ neutrals) that make it through a slit in the second magnetic section 920. The upper path, “a”, of neutrals is the path of neutrals originally going up (at an angle). The second path going downward is not shown for clarity sake. The magnetic gradient interacts with the spin resulting in a force down (path a). Vise versa with the lower path (not shown). With a reverse gradient in the third magnetic system the paths would exit the apparatus and be counted by the detector 950 (Note: The second magnetic system imparts no force since it's uniform). Since the magnetic gradient in the third magnetic section 930 is opposite in direction than the gradient in the first magnetic section 910, the spin particles associated with path “a” now experience an upward force and are bent upward in a third magnetic region within the third magnetic section 930.

If a slight horizontal magnetic field is oscillating in the second magnetic section then a transition in energy (spin) can occur. For example an oscillating horizontal field circuit 940 can produce an oscillating horizontal field in the second magnetic section 920. The portions of spin particles that undergo a flipped spin state will now have a different path, “b”, in the third magnetic section. The portion that did not flip it's spin will continue along the solid path “a.” The spin flipped portion traveling along path “b” will now collide with a surface of the third magnetic section 930. This results in a decrease in the detector current when a weak horizontal magnetic field is oscillated at the transition (resonance) frequency (eqn. 3). The probability of spin flipping is very sensitive to the resonance frequency of the oscillating horizontal field in the second magnetic section and is such that various atoms could be distinguished by their resonance frequency. Once the spin is in a state, it interacts with a gradient magnetic field and it's interaction is generally expressed as:

$$\begin{matrix}{{F}_{z}}^{ϖ} = - \frac{ⅆ {U}^{w}}{ⅆ z} \\ = - {μ}^{ϖ} \cdot \frac{ⅆ {B}^{w}}{ⅆ z} \\ = - {μ}_{z} \frac{ⅆ {B}_{z}}{ⅆ z}\end{matrix} \qquad ( 4 )$$

Where μ_{z} is the magnetic dipole moment of the particle in the gradient magnetic field in the z-direction (Note although B is really the magnetic induction, it is referred to herein as the magnetic field). To have a deflection in a gradient magnetic field a net spin is needed. This is normally supplied by a valence electron (Physics for Scientists and Engineers, Douglas C. Giancoli 3^{rd} ed., pg. 1017, lines 14-15). When an atom has a net spin and travels in a gradient magnetic field, the atom experiences a force linearly related to the magnetic dipole moment of the atom (eqn. 4).

The magnetic dipole moment (μ) is a function of the Bohr magnetron

$$( {μ}_{B} = \frac{e \overline{h}}{2 {m}_{e}} , 9.27 \times {10}^{- 24} J / T ) ) ,$$

the spin quantum number “mₛ” and a gyromagnetic ratio “g” and can be stated as:
μ=−gμ_{B}mₛ (5)

where

$${μ}_{B} = \frac{e \overline{h}}{2 {m}_{e}}$$

is the Bohr magnetron (9.27×10⁻²⁴ J/T), note that a proton magnetron, μₚ can be similarly expressed as the Bohr magnetron with the mass of the proton substituted for the mass of the electron (mₑ). Many neutral atoms have various “g” values, and thus have various magnetic dipole moment, for example, in terms of the ratio of the proton magnetron and a nuclear magnetron, the following atoms have the following ration values: ¹⁵O(0.719), ¹⁷O(−1.8938), ¹⁴N(0.40376), ¹³C(0.70241), n(−1.913043), ¹H(2.79285), ³He(−2.12762), ¹⁹F(2.62887), ²¹Ne(−0.66180), ³⁵Cl(0.82187), ³⁷Cl(0.68412), and ¹²⁹Xe(−0.7780) (CRC Handbook of Chemistry and Physics, 75^{th} Edition, 1995, Tables 11-36, 1140, and 11-78).

The magnetic dipole moment (μ) can be expressed in terms of the nuclear magneton (μₚ) as:
μ=−1836.152gμₚmₛ≈−3672μₚmₛ (6)

We would expect the proton magnetron (μₚ) to be the same as the nuclear magnetron (μ_{N}) but it is one of the mysteries of quantum mechanics that it is not (Physics for Scientist and Engineers, 3^{rd} Ed., pg. 1064, lines 13-14, Douglas C. Giancoli). The proton magnetron can be expressed in terms of the nuclear magnetron by a factor α (μ_{N}=5.05×10⁻²⁷ J/T).
μₚ=αμ_{N}

Each spin particle (e.g., electron, atom with net spin,) has a different value of α, which can be used to identify the spin particle for example table 1 (from the CRC Handbook of Chemistry and Physics, 75^{th} Ed., 1995, Tables 9-84, 9-85) illustrates various values of α=(μₚ/μ_{N}).

TABLE 1

| Isotope | Spin | | | |
|---|---|---|---|---|
| (amu) | mₛ | Abundance | μₚ/μ_{N} α | Atomic Mass |
| ¹n | ½ | | −1.91304275 | 1.008665 |
| ¹H | ½ | 99.985 | 2.7928474 | 1.00794 |
| ²H | 1 | 0.015 | 0.8574382 | 2.0140 |
| ³He | ½ | 0.0001 | −2.1276248 | 3.01603 |
| ¹⁴N | 1 | 99.634 | 0.4037610 | 14.003074 |
| ¹⁷O | 5/2 | 0.038 | −1.89379 | 16.999131 |
| ¹³C | 1/2 | 0.10 | 0.7024118 | 13.003355 |

Now we can express the magnetic dipole moment in terms of the nuclear magnetron.
μ=−3672αμ_{N}mₛ (8)
Thus now the force on a spin particle in a gradient magnetic field can be expressed in terms of α as:

$${F}^{ϖ} = - \frac{ⅆ U}{ⅆ z} = - ( - 3672 α {{μ}^{ϖ}}_{N} {m}_{s} ) \cdot \frac{ⅆ {B}^{ω}}{ⅆ z} \qquad ( 9 )$$

Introduction to the Detection of Low Energy Neutral Atoms

Often the detection of neutrals lends to the determination of magnetic fields and environmental characteristics. For example the plasma trapped in the Earth's magnetic field can interact with the ambient hydrogen exosphere such that the plasma obtains a neutralizing electron escaping as a newly formed neutral atom. The neutral atom can be detected and the magnetic field can be inferred. The detection of the magnetic fields adds to our overall knowledge of the environment through measurement. Without actual measurement one can not be absolutely sure one understands all of the causal relationships linking the world with models. One of the problems with such measurements is that, as quantum mechanics has taught us, measurement changes the environment we seek to understand.

Conventional methods of neutral atom detection ionize the neutral and pass the result through a mass spectrometer. However such methods change the energy of the neutral that is being detected. In some cases where the energy of the neutral is much higher tan the ionizing energy the sacrifice in energy certainty is acceptable. However when studying lower energy neutrals (e.g., at room temperature) of about 0.1-10 eV, the ionization process can appreciably change the energy intended to be measured.

Some methods seek to add an electron, such as the LENA (Low Energy Neutral Atom) detector aboard NASA's IMAGE satellite. However the current LENA system uses low work function material (cesium in the case of LENA). Low work function materials have a tendency to outgas in low vacuums leaving only a few monolayers, additionally impact with the surface is needed to transfer the extra electron, which changes the energy and initial direction of the neutral.

Introduction to Fusion Methods

Historical interest in fusion has centered around the plasmatization of fusion fuel (e.g., Deuterium (D), Hydrogen (H)) so that the separate ions in the plasma contain enough energy to overcome electrostatic repulsion and combine. Very few if any studies have looked at the use of spin manipulation to combine hydrogen into helium in a fusion process without ionization.

Typical fusion calculations calculate the temperature (i.e., the kinetic energy) requirements to bring two nuclei together to fuse assuming that each nuclei has a net charge and that the kinetic energy matches the Coulomb force. For example the radius of a deuterium atom is roughly 1.5 fm (femtometer=1×10ˆ-15 m) and the radius of tritium is roughly 1.7 fm. Thus the temperature for fusion will be approximately equal to the temperature needed to overcome the Coloumb force between two positive nuclei and bring them within 3.2 fm. This relationship can be expressed as:

$$2 K . E . \approx k \frac{{ⅇ}^{2}}{( {r}_{d} + {r}_{t} )} \approx 0.45 Me V \qquad ( 10 )$$

Where K.E. is the kinetic energy of both nuclei. The temperature of each nuclei can be solved using it's average kinetic energy (half that calculated in (10)):

$$\begin{matrix}\frac{3}{2} kT = 0.22 Me V -> \\ T = \frac{2 K . {E}_{nuclei}}{3 k} \\ = \frac{2 ( 0.22 Me V ) ( 1.6 \times {10}^{- 13} J / Me V )}{3 ( 1.38 \times {10}^{- 23} J / K )} \\ = 2 \times {10}^{9} K\end{matrix} \qquad ( 11 )$$

The high temperature has led to the formation of the field of plasma fusion, where physicists are attempting to increase the plasma density and temperature to levels needed to sustain fusion. Typically it has been estimated that a temperature lower than that of the example above is needed, approximately 4×10⁸ K, for commercial fusion reactor. This corresponds to a fuel atom having 5.52×10⁻¹⁵ J or 34,500 eV of translational energy.

In addition to temperature a certain density is needed for a certain period of time to maintain a steady level of collisions to sustain ignition. J. D. Lawson showed that the product of the ion density n and the confinement time t_{c} should be above a certain level to produce ignition. The relationship can be expressed as:
nt_{c}≧3×10²⁰s/m³

In conventional fusion systems the density is either to low, or the temperature not high enough, or the confinement time not high enough.

### SUMMARY OF THE INVENTION

Exemplary embodiments of the invention are directed to devices and methods of system manipulation using the system's quantum spin.

At least one exemplary embodiment is directed to an apparatus using quantum spin to manipulate particles having spin to create a force or current, comprising: a magnetic gradient production apparatus, where the magnetic gradient production apparatus is configured to generate a magnetic field gradient in at least two directions, a first direction and a second direction; and a control circuit, where the control circuit controls the magnetic field gradient, wherein the magnetic field gradient produces a first force on the particles separating the particles into a pro-gradient spin portion and an anti-gradient spin portion, where at least one of the spin portions is spatially confined in the first direction.

At least one exemplary embodiment is directed to an apparatus using quantum spin to manipulate particles having spin to create a force or current, comprising: a magnetic gradient production apparatus, where the magnetic gradient production apparatus is configured to generate a magnetic field gradient in at least one direction, a first direction; and a control circuit, where the control circuit controls a magnetic field gradient, where the magnetic field gradient produces a first force on the particles separating the particles into a pro-gradient spin portion and an anti-gradient spin portion, where the first force causes a motion of the pro-gradient spin portion in the direction of the magnetic gradient and the first force causes a motion of the anti-gradient spin portion in an opposite direction from the magnetic gradient.

At least one exemplary embodiment is directed to a spin particle detection device comprising: a first magnetic gradient region; a second magnetic gradient region; a uniform magnetic field region; an oscillating magnetic field region; a control circuit, where the control circuit sets an oscillating frequency for the oscillating magnetic field region, where the oscillating magnetic field is configured to change the spin orientation of at least one spin particle; and a first detector, where the first detector is configured to detect the at least one spin particle if it had its spin orientation changed.

Further areas of applicability of embodiments of the present invention will become apparent from the detailed description provided hereinafter. It should be understood that the detailed description and specific examples, while indicating exemplary embodiments of the invention, are intended for purposes of illustration only and are not intended to limited the scope of the invention.

### BRIEF DESCRIPTION OF THE DRAWINGS

Embodiments of present invention will become more fully understood from the detailed description and the accompanying drawings, wherein:

FIG. 1A is an illustration of the Stern Gerlach experiment;

FIGS. 1B-1L illustrate various methods and/or devices for magnetic gradient production in accordance with exemplary embodiments;

FIGS. 2, and 2A-2B illustrates a micro/nano spin switch device/apparatus in accordance with at least one exemplary embodiment;

FIG. 3 illustrates a spin transistor (spinsistor) according to at least one exemplary embodiment;

FIG. 4, 4A-4D illustrates a spin transistor (spinsistor) according to at least one exemplary embodiment;

FIG. 5 illustrates a spinsistor according to at least one exemplary embodiment;

FIG. 5A illustrates a table listing a tri value for the spinsistor illustrated in FIG. 5;

FIG. 6 illustrates a spinsistor according to at least one exemplary embodiment;

FIG. 6A illustrates a table listing a tri value for the spinsistor illustrated in FIG. 6;

FIGS. 7, and 7A-C illustrates a spin voltage variation capacitor (spinacitor) according to at least one exemplary embodiment;

FIGS. 8, 8A-C illustrates a propulsion device according to at least one exemplary embodiment;

FIG. 9 illustrates the Rabi experiment;

FIG. 10 illustrates a spin particle detector according to at least one exemplary embodiment;

FIG. 11 illustrates a possible detector arrangement for the detector illustrated in FIG. 10;

FIG. 12 illustrates a spin accelerator according to at least one exemplary embodiment; and

FIG. 13 illustrates a coil spin accelerator according to at least one exemplary embodiment.

### DETAILED DESCRIPTION OF EXEMPLARY EMBODIMENTS OF THE PRESENT INVENTION

The following description of at least one exemplary embodiment is merely illustrative in nature and is in no way intended to limit the invention, its application, or uses.

Processes, techniques, apparatus, and materials as known by one of ordinary skill in the relevant art may not be discussed in detail but are intended to be part of the enabling description where appropriate, for example control circuits for varying current flow.

In all of the examples illustrated and discussed herein any specific values, for example substrate sizes, current levels, and magnetic field gradient values, should be interpreted to be illustrative only and non limiting. Thus, other examples of the exemplary embodiments could have different values.

Notice that similar reference numerals and letters refer to similar items in the following figures, and thus once an item is defined in one figure, it may not be discussed for following figures.

### SUMMARY OF EXEMPLARY EMBODIMENTS

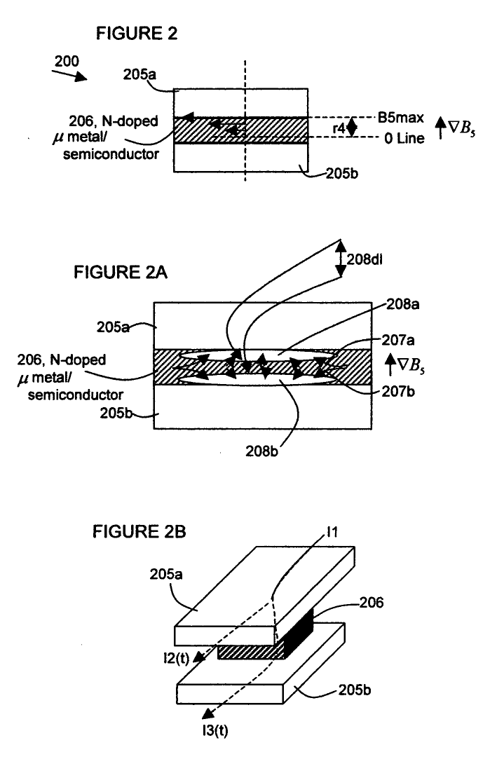

The first exemplary embodiment is directed to an apparatus that creates a force on particles (e.g.,. atoms, ions, molecules, electrons, fluids and solids with a net spin, and other spin particles as known by one of ordinary skill in the relevant arts) using the magnetic gradient-spin interaction force (e.g., as illustrated in the Stern-Gerlach experiment). The force exerted can be used to separate spin particles in a medium (e.g., gas, semiconductor, a magnetic suppressant N-doped layer and other mediums that allow the spin particles to initially respond to a gradient magnetic field as known by one of ordinary skill in the relevant arts and equivalents). In the first exemplary embodiment the separated spin particles are grouped into a pro-gradient portion(s) (PGP) and an anti-gradient portion(s) (AGP) and confined after initial separated by a barrier (e.g., physical interface between substrate layers, or via magnetic field gradient) so that the separation of PGP and AGP can be used to trigger the flow of currents or the creation of voltage differences between the layers in which the AGP and PGP reside. Several non-limiting examples have been provided (e.g., FIGS. 2, 2B, 3-6, and 7A-C)

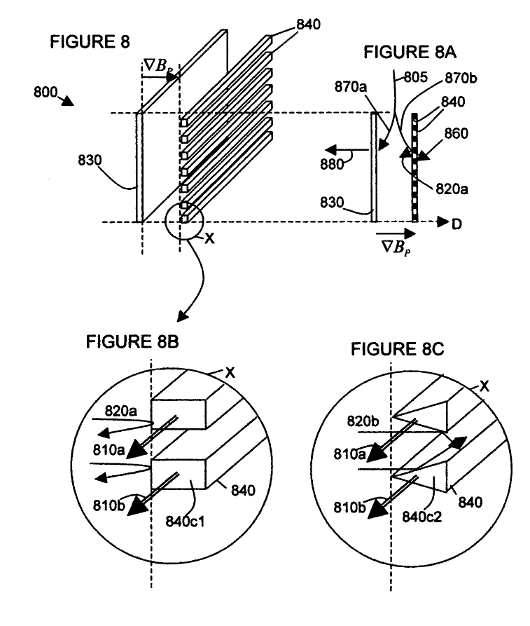

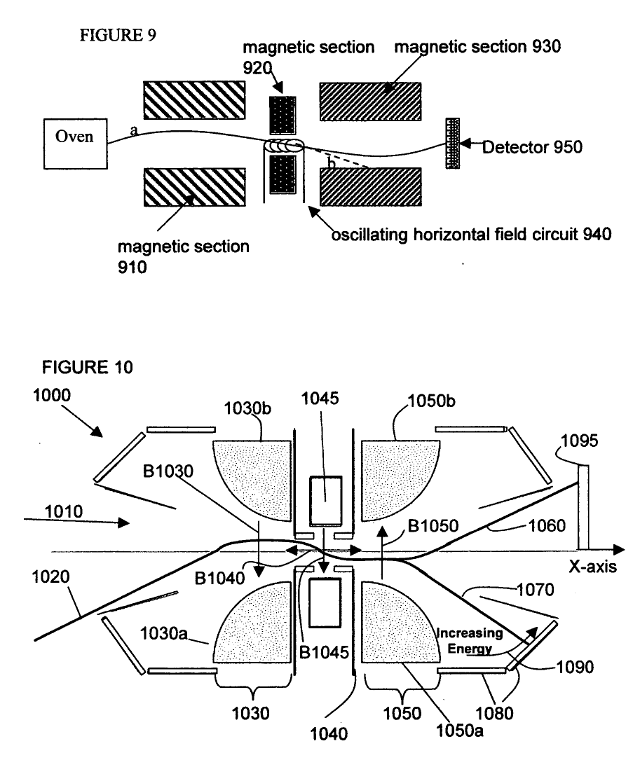

The second exemplary embodiment is directed to an apparatus that creates a force in the same way as that in the first exemplary embodiment, however now the force accelerates spin particles along a motion magnetic field gradient direction unbounded by a barrier along the motion magnetic field gradient. Several non-limiting examples have been provided (e.g., propulsion device (FIG. 8), accelerator (FIG. 12), fusion coils (FIG. 13)).

The third exemplary embodiment is directed to an apparatus that creates a force in the same way as that in the first exemplary embodiment without a barrier. A further oscillating magnetic field is used to change the spin particle's spin (spin-flip) so that the force initially experienced will be opposite than previously experienced (e.g., a AGP is flipped to a PGP). The changed spin particle will be detected directly by a first detector, which can measure the energy by the placement of its landing and the particle by the oscillating frequency used. A non-limiting example has been provided (e.g., neutral atom detector (FIG. 10)).

Note that further exemplary embodiments can be developed based upon the inventive processes described herein and the present invention is not limited to only the discussed exemplary embodiments nor the specifics of any example (e.g., numerical or otherwise) provided.

### First and Second Exemplary Embodiments

The first exemplary embodiment is directed to an apparatus that creates a force on particles (e.g.,. atoms, ions, molecules, electrons, fluids and solids with a net spin, and other spin particles as known by one of ordinary skill in the relevant arts) using the magnetic gradient-spin interaction force (e.g., as illustrated in the Stem-Gerlach experiment).

Several examples of magnetic gradient production apparatus are discussed herein. In accordance with the first exemplary embodiment the magnetic field gradient moves PGP and AGP into separate locations affecting the electronic nature of a substrate similar to transistor operation. As in transistor operation the movement of electrons in n-doped and holes in p-doped materials is analogous herein since PGP and AGP are typically electrons (having spin mₛ=½) which behave the same way as n-doped electrons. Thus the discussion herein with respect to exemplary embodiments will focus on generating the magnetic field gradients in the substrates moving AGP and PGPs. The movement of these AGPs and PGPs provide a substrate with similar character tics as a n-doped substrate and thus the operation of n-doped substrates will not be discussed.

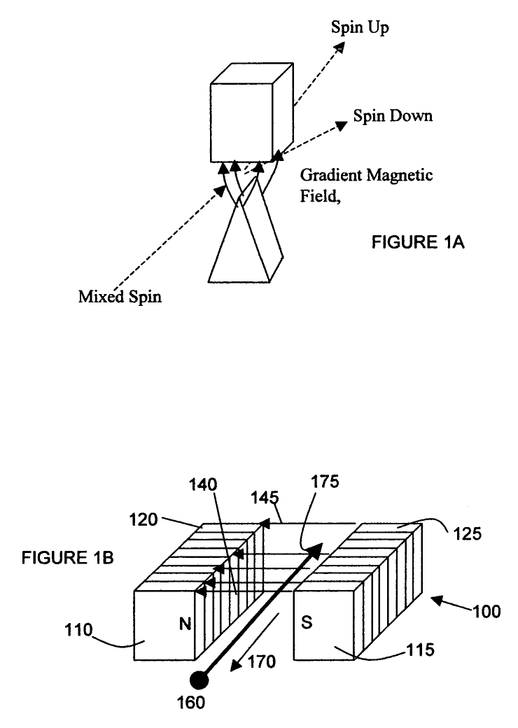

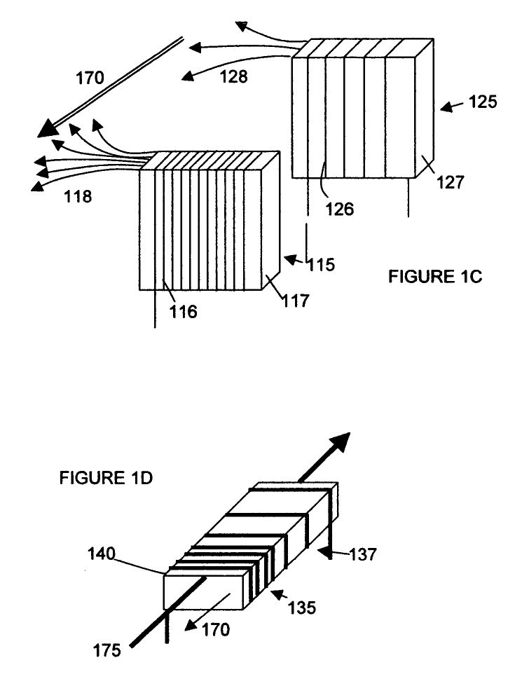

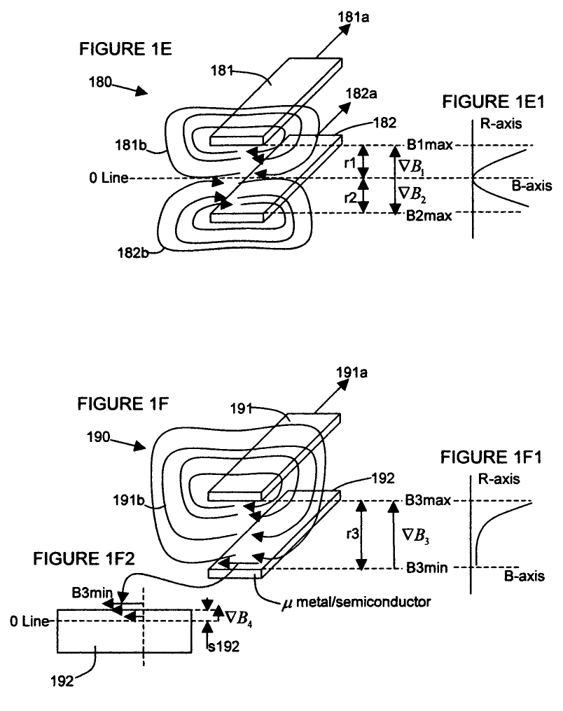

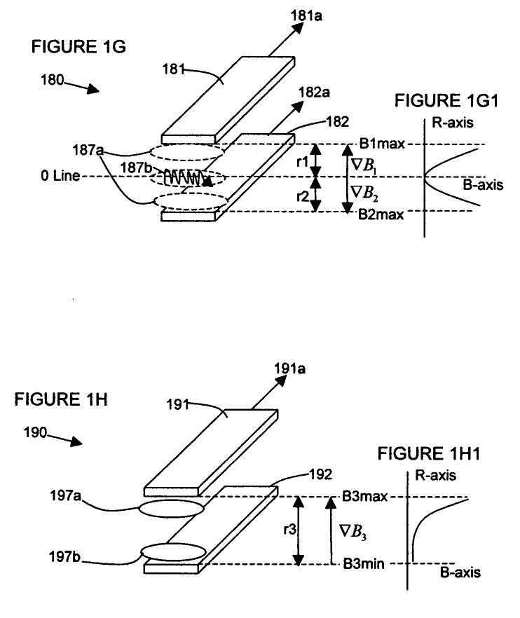

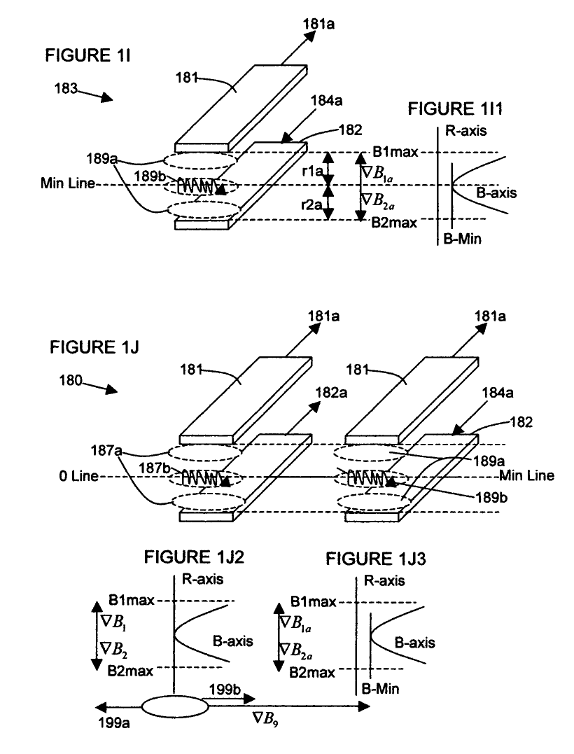

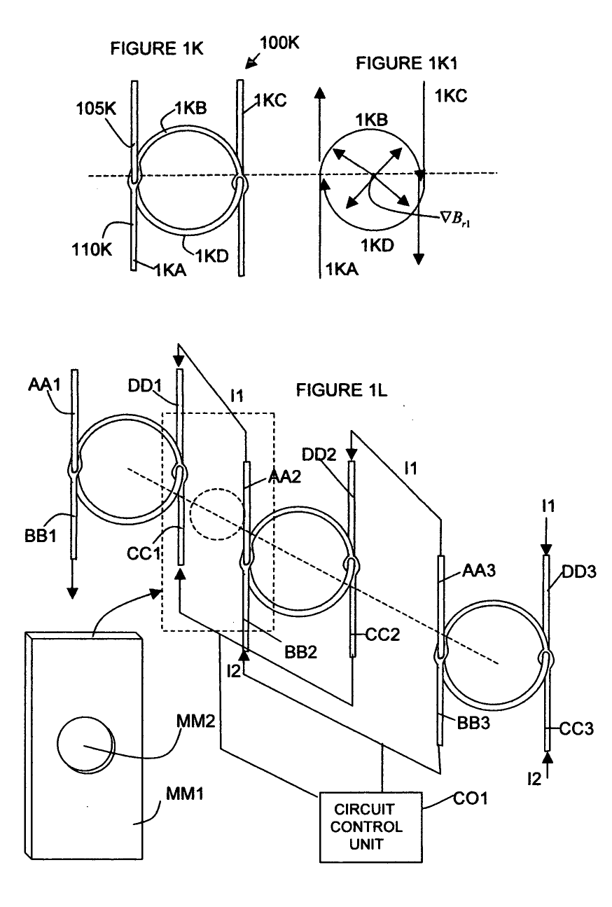

FIG. 1B illustrates a first non-limiting examples of a magnetic gradient production apparatus 100, including a first side magnetic section (e.g., first side first element 110, first side second element 120), and a second side magnetic section (e.g., second side first element 115, second side second element 125). This example illustrates permanent magnets but magnetic cores with wire loops or just wire loops can be used. The magnetic field gradient 170 can be produced by the second side first element 115 and the first side first element 110 having a larger field value than the second side second element 125 and the second side first element 120. A spin particle, in this case a AGP particle experiences a force opposite to the magnetic field gradient 170.

FIGS. 1C and 1D illustrate further examples, the first (FIG. 1C) where coils (116 and 126) are used around respective cores (117 and 127) to produce the magnetic field gradient 170. FIG. 1D uses a hollow chamber surrounded by various spacing of the wounding coil, where at one end the wounding is closer spaced (135) and at the other end is farther spaced (137) producing the magnetic field gradient 170.

Wires can also produce magnetic fields and thus can produce gradients, for example a straight wire with a current I (in this example, 0.025 Amps) passing through it produces a magnetic field that is a function of the radial distance “r” (in this example, 1×10⁻⁶ m) away from the wire, which can be expressed as:

$$B = \frac{{μ}_{0} I}{2 π r} = \frac{( 4 π \times {10}^{- 7} T m / A ) ( .025 A )}{( 2 π ) ( 0.000001 m )} = 5.0 \times {10}^{- 3} T \qquad ( 13 )$$

If two wires are parallel and have currents traveling through them then their respective magnetic fields will add/subtract. For example FIGS. 1E-F illustrate two thin substrates 181 and 182 with respective currents 181a and 182a flowing within. If the currents are in the same direction the respective magnetic fields 181b and 182b will subtract from each other. If the currents 181a and 182a are in the same direction then directly between both substrates 181 and 182 the magnetic field will cancel. Thus this location will have a near zero value for the magnetic field, whereas the magnetic field near the surface of each substrate 181 and 182 will be maximum. Thus a radial magnetic gradient forms (see FIG. 1E1). The location of the zero point (O-Line) will depend on the respective currents 181a and 182a values.

Another example is illustrated in FIG. 1F, where one current flows 191a which produces a magnetic field 191b, and a parallel magnetic field suppressing substrate 192 (e.g., mu metal, mu-semiconductor, mu-insulator, for example see “Variation of magnetization and Lande g factor with thickness in Ni—Fe films”, J. P. Nibarger et al, Applied Physics Letters, Vol. 83, No. 1, 7 July 2003; “Manipulating the L-valley electron g factor in Si—Ge heterostructures”, F. A. Baron et al., Physical Review B, Vol. 68, 195306, 2003). Thus a magnetic field gradient as illustrated in FIG. 1F1 occurs. Inside the magnetic suppressing substrate 192, the magnetic field penetrates to an attenuation layer (0-Line) position in a small distance (e.g., the thickness of substrate 192, nanometers) which can result in a very large gradient (FIG. 1F2). Such magnetic suppressing substrates 192 and regular substrates (e.g., any substrate that can be P- or N-doped) can be used to form devices for example as illustrated in FIGS. 2, 2A, 2B, 3, 4, 4A-4D, 5, 6, 7, 7A-C. These examples of devices can use two current substrates as illustrated in FIG. 1E or one current substrate and a magnetic field suppressing substrate as illustrated in FIG. 1F. Additionally a material is inserted between the substrates, where the material (e.g., any magnetic suppressing material, any materials that can be P-doped and N-doped) can be subject to the magnetic field gradients formed, resulting in the formation of AGP and PGP within the material, which will allow the material to behave similar to no-doped material if the spin particles are electrons.

FIG. 1G illustrates the separation of any spin particles between the current carrying substrates of FIG. 1E, into three regions, a single region of AGP spin particles 187b and two regions of PGP 187a. However in the system illustrated in FIG. 1H (with the arrangement illustrated in FIG. 1F) since there is no 0-Line or minimum line between the substrates, there are only two regions an AGP region and a PGP region.

FIGS. 1I and 1I1 illustrate the field configuration when the two currents are in opposite direction. If one calculates the magnetic field, even though they ad in the middle, the values are larger nearer to the substrates (FIG. 1I1), thus there is no 0-Line but a Min Line in the center.

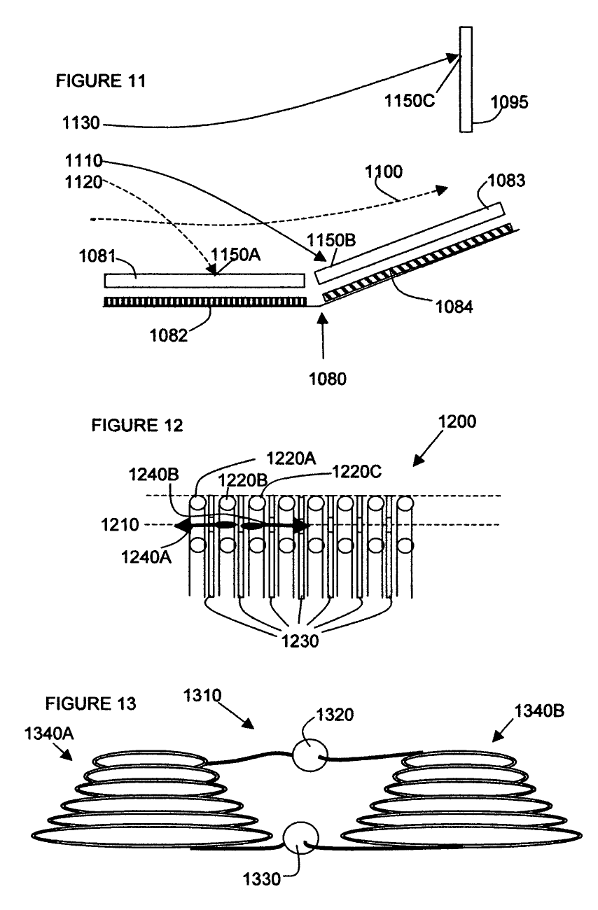

If the arrangement in FIG. 11 is placed next to the arrangement illustrated in FIG. 1E, both of which have central minimum values, a non-radial gradient occurs from the 0-Line region toward the Min-Line region. The gradient will depend upon the spacing of the two sets of substrates from each other. Now the AGP spin particles along the 0-Line will feel a gradient toward the Min Line and thus these particles will split into two more portions (199a AGP-axial, 199b PGP-axial) of particles, one accelerated toward the Min line and another away from the Min line. The two portions are dependent upon their spin states along the perpendicular distance from the radial direction. Thus the two sets of substrates acts as an accelerator (second exemplary embodiment). A control circuit can be used to continuously keep the Min-Line infront of a PGP-axial spin particle, and the O-Line continuously infront of the AGP-axial spin particle varying the current flow in neighboring substrates or coils.

For example FIGS. 1K and 1L illustrate two loop coils where one loop 105K passes through the second coil 110K,. A first current 1KC flow through the coil 105K around the loop 1KD, while a second current flows 1KA through a loop 1KB. The current flow produces a near radial magnetic field gradient (FIG. 1K1). Thus AGP spin particles will be confined in a first and second direction defining the plane of the two coil loops, toward the center, while the PGP tends toward the loops themselves. As discussed with respect to neighboring substrates (coils) (FIG. 1J) neighboring coils can be used to form an accelerator down a centerline. Note to block the PGP from moving each coil can be separated by a magnetic suppressing barrier MM1 with an opening MM2 to allow the accelerated AGP to pass. Note that the same I1 and I2 from neighboring coils can be used, although separate coil currents can also be used. A control circuit CO1 can be used to vary currents I1 and I2 so that an AGP-axial spin particle always see a gradient infront of it along the centerline. This can be accomplished by calculating the force (equation 9) and the resultant speed of the accelerated spin particles and then varying the current in neighboring coils based on the spacing between coils and the velocity of the spin particles.

FIGS. 2, 2A, 2B, 3, 4, 4A-4D, 5, 6, 7, 7A-C, 8, 12, and 13 illustrate various examples using the gradient producing methods discussed, materials allowing AGP and PGP separation. For example FIG. 12 illustrates an accelerator 1200, with neighboring coils accelerating AGP-axial and PGP-axial spin particles linearly. FIG. 13 illustrates acceleration coils where an initial spin particle medium region 1320 using multiple expanding loops can be used to increase the acceleration of the AGP-axial and PGP-axial spin particles to collide in a collision region 1330 in accordance with the discussion herein.

FIG. 2 illustrates a closeup of two current substrates 205a and 205b with a magnetic suppressing material 206 sandwiched between the substrates 205a and 205b. As discussed currents in the substrates 205a and 205b will result in magnetic field gradients in material 206. FIG. 2A illustrates the separation of AGP spin particles 207b and PGP spin particles 207a. If the spacing between the two regions 207a and 207b is small enough, a current can pass from substrate 205a to substrate 205b. If the current flows then the current in say 205a will be suppressed and flow into 205b (FIG. 2B). The decrease in current I1 will decrease the gradient until the AGP and PGP regions are not well enough defined to allow the current to flow and thus the full current switches back to substrate 205a. This can be used to generate an oscillating current.

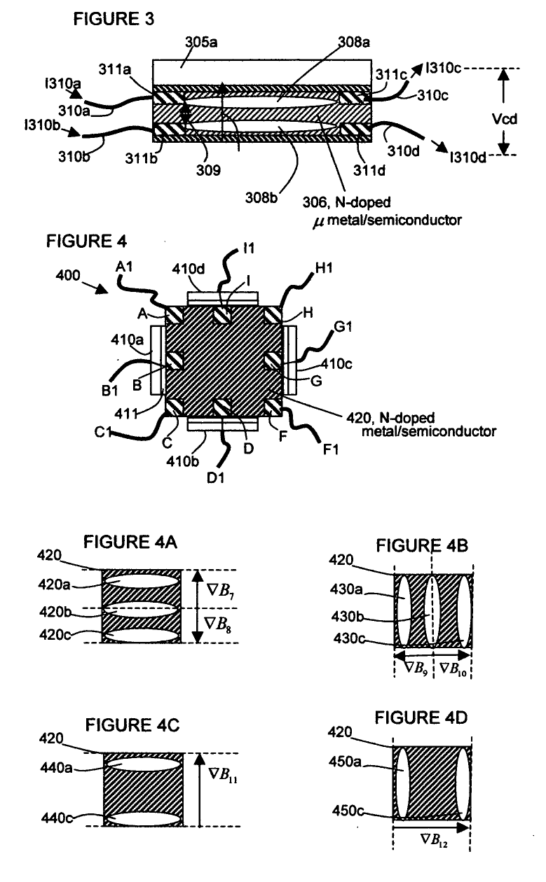

FIG. 3 illustrates another device where a current carrying substrate 305a is separated by a magnetic suppressing layer 306, by an insulating region prohibiting current from flowing. Several contacts 311a, 311b, 311c, and 311d can be used to allow a current to flow from one contact to another when the AGP and PGP regions (e.g., 308a, 308b) develop, which is referred to as a spinsistor

Likewise FIG. 4 illustrates a two dimensions version of a spinsistor as in the example illustrated in FIG. 3, and FIGS. 4A-4D illustrate the various AGP and PGP distributions.

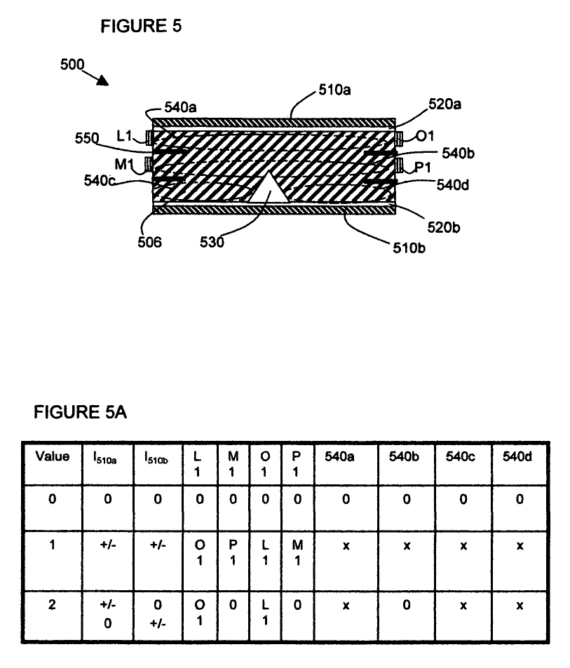

FIG. 5 illustrates another spinsistor 500 arrangement with two current carrying layers (510a and 510b) a barrier 530 (e.g., insulator, SiO2) prohibiting any flow from the region 540c to 540d).

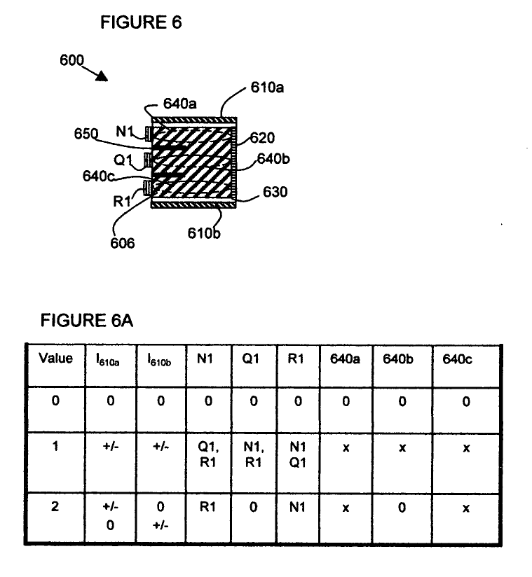

FIG. 5A illustrates logical values associated with various AGP and PGP distributions, which vary (as describe above) in response to currents flowing through the substrates 510a and 510b. FIG. 6 and 6A illustrate yet another variation of a spinsistor.

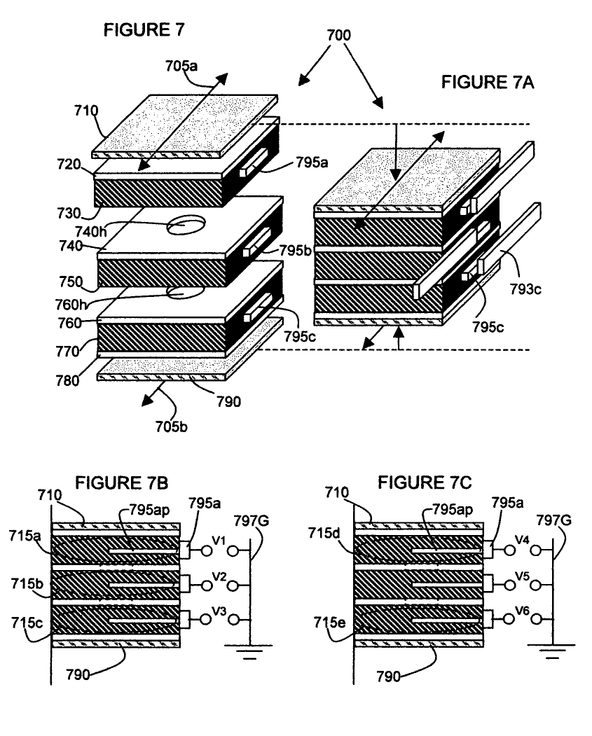

FIG. 7 illustrates a capacitor arrangement using the principles discussed, with varying currents in the current carrying layers 710 and 790 resulting in AGP and PGP regions 715a, 715b, and 715c having associated voltages V1-V3. While when one current is set to zero the AGP and PGP regions 715d and 715e have different voltages associated V4, V5, and V6. this device can be used to vary voltage along a line when the currents are varied.

FIG. 8 illustrates a propulsion device in accordance with the principals discussed.

### Third Exemplary Embodiment

The third exemplary embodiment is directed to an apparatus that detects spin particles (e.g., neutral atom detector (FIG. 10)).

The spin particle detection device 1000, includes a first magnetic gradient region 1030, a second magnetic gradient region 1050, a uniform magnetic field region (region in which vertical magnetic field B1045 lies), an oscillating magnetic field region (region in which horizontal magnetic field B1040 lies), a control circuit (not shown) connected to the oscillating coil 1040, where the control circuit sets an oscillating frequency for the oscillating magnetic field region. The oscillating magnetic field can cause a spin flip in a spin particle in the uniform region (e.g., from mₛ=½ to mₛ=−½). The changing of the spin effects the value of the force the spin particle encounters in the second magnetic gradient region 1050 (equation 9).

In the third exemplary embodiment the spin flipped spin particle travels a path, that in the Rabi experiment would encounter the magnets (e.g., 1050a, and 1050b) in the second magnetic gradient section 1050, that travels to a detector (e.g., a simple Multi-channel plate and underlying anode grid). The placement of the impact on the detector 1080 can be calibrated so that the energy can be determined 1090. Additionally the oscillating frequency used for the oscillating coil 1040 will select only those spin particles with a particular a value, thus first a particular spin particle can be selected for detection and then it's placement on detector 1080 will determine its energy.

In addition a second detector 1095 can be placed similar to that in the Rabi experiment to measure the undeflected current. The combination of the current detected in both detectors allows a measurement of the total flux (current), Fₜ, of a particular spin particle (e.g., mₛ=½) by detector 1095 before the oscillating magnetic field occurs. Then the oscillating magnetic field enables one to measure the decrease in the current measured by detector 1095, F₁. Then the current measured by detector 1080 F₂ provides the information needed to measure the amount of the selected spin particle that is spin flipped.

As an example, several simulations were run, with three spin particles, ¹n, ¹H, and ²H each having 10 eV of energy, with a 0.0 inclination angle with respect to the X-axis (FIG. 10), a 4 mm opening, using a magnetic gradient of 100 T/m, with only the second magnetic section 1050 and detector 1080 simulated. The three spin particles (¹n, ¹H, and ²H) impinged the detector 1080 at distances of 1.355 m, 1.1368 m, and 1.4229 m, providing resolution distance between these spin particles of about 7 cm. Thus in this non-limiting example, the spin particles, having the same energy, impinge on the detector 1080 at difference locations. For various energies each spin particle location on detector 180 can be calibrated.

The first and second magnetic gradient regions 1030 and 1050 can includes multiple magnetic field generating devices (e.g., 1030a-b, 1050a-b) for example permanent magnets (e.g., see company FERROXCUBE™ products, some up to 9 Teslas), a magnetic core with wire loops or other magnetic field generating devices as known by one of ordinary skill in the relevant art and equivalents.

The description of the invention is merely exemplary in nature and, thus, variations that do not depart from the gist of the invention are intended to be within the scope of the embodiments of the present invention. Such variations are not to be regarded as a departure from the spirit and scope of the present invention.

What is claimed is:

1. An apparatus using quantum spin to manipulate particles having spin to create a force or current, comprising:
a magnetic gradient production apparatus, wherein the magnetic gradient production apparatus is configured to generate a magnetic field gradient in at least two directions, a first direction and a second direction; and
a control circuit, wherein the control circuit controls the magnetic field gradient, wherein the magnetic field gradient produces a first force on the particles separating the particles into a pro-gradient spin portion and an anti-gradient spin portion, wherein at least one of the spin portions is spatially confined in the first direction.

2. The apparatus according to claim 1, wherein the spin portion confined is also spatially confined in the second direction.

3. The apparatus according to claim 2, wherein the spin portion confined is the anti-gradient portion.

4. The apparatus according to claim 1, wherein the magnetic gradient production device comprises:
a first current carrying element; and
a second current carrying element, wherein the first current carrying element and the second current carrying element are substantially parallel, and the first current carrying element has a first current passing through and the second current carrying element has a second current passing through.

5. The apparatus according to claim 1, wherein the magnetic gradient production device comprises:
a first current carrying element; and
a first magnetic field suppression element, wherein the first current carrying element and the first magnetic field suppression element are substantially parallel, and the first current carrying element has a first current passing through and the magnetic field generated by the first current is suppressed by the first magnetic field suppression element.

6. The apparatus according to claim 4, wherein the first current is in the same direction as the second current.

7. The apparatus according to claim 6, further comprising a medium between the first current carrying element and the second current carrying element, wherein the medium includes at least one spin particle, and wherein the control circuit controls a magnetic field gradient variation of a portion of the magnetic field gradient, wherein the magnetic gradient variation produces a second force substantially perpendicular to the first force on at least one particle having spin.

8. The apparatus according to claim 3, further comprising:
a first current carrying element;
a second current carrying element wherein the first current carrying element and the second current carrying element are substantially parallel, and the first current carrying element has a first current passing through and the second current carrying element has a second current passing through;
at least two insulating layers, a first insulating layer and a second insulating layer, wherein the first and second insulating layers are positioned within a first medium separating the first medium into a first, second, and third region, and wherein the first medium lies between the first and second current carrying elements; and
at least three contacts, a first contact, a second contact, and a third contact, wherein the first contact is operatively connected to the first region, eth second contact is operatively connected to the second region, and the third contact is operatively connected to the third region.

9. The apparatus according to claim 8, wherein when a first current is passed through the first current carrying element and a second current is passed through the second current carrying element, spin particles in the first medium separate in the first medium so that the first, second and third regions are associated with a particular spin particle state, raising the voltage at the first, second and third contacts.

10. The apparatus according to claim 9, wherein when the second current is set to zero, the spin particles rearrange themselves so that they are significantly associated with the first and third region, changing the voltage at the first, second, and third contacts.

11. The apparatus according to claim 1, further including:
a first contact; and
a second contact, wherein a current from the first contact flows through either the pro-radient spin portion or the anti-gradient spin portion to the second contact, generally parallel to the second direction.

12. An apparatus using quantum spin to manipulate particles having spin to create a force or current, comprising:
a magnetic gradient production apparatus, wherein the magnetic gradient production apparatus is configured to generate a magnetic field gradient in at least one direction, a first direction; and
a control circuit, wherein the control circuit controls a magnetic field gradient, wherein the magnetic field gradient produces a first force on the particles separating the particles into a pro-gradient spin portion and an anti-gradient spin portion, wherein the first force causes a motion of the pro-gradient spin portion in the direction of the magnetic gradient and the first force causes a motion of the anti-gradient spin portion in an opposite direction from the magnetic gradient.

13. The apparatus according to claim 12, wherein the magnetic gradient production device comprises:
a first set of magnets; and
a second set of magnets, wherein the first set and the second set of magnets are substantially arranged parallel to each other, and wherein there is a parallel magnetic field gradient in about the parallel direction.

14. The apparatus according to claim 13, wherein the first set of magnets includes a
plurality of first sub-magnet cores, and second set of magnets includes a plurality of second sub-magnet cores, wherein the first sub-magnet cores have associated respective first wire coils of various first wounding, and wherein the second sub-magnet cores have associated respective second wire coils of various second wounding, wherein variations in the first and second wounding result in the about parallel magnetic field gradient.

15. The apparatus according to claim 12, wherein the magnetic gradient production device comprises:
a tube; and
a set of wire woundings around the tube, wherein a varying number of windings around the tube in a tube axial direction results in a magnetic field gradient in about the axial direction when current is run through the wire woundings.

16. The apparatus according to claim 12, wherein the magnetic gradient production device comprises:
a first wire loop; and
a second wire loop, wherein the first wire loop passes through a portion of the second wire loop, wherein the first wire loop is configured to pass a first current through and the second wire loop is configured to pass through a second current, wherein the first current and the second current produce a magnetic field gradient within a region bound by the intersection of the first wire loop and the second wire loop.

17. A spin accelerator comprising:
a plurality of magnetic gradient units, wherein each magnetic gradient unit includes the apparatus according to claim 16, wherein alternative magnetic gradient units in the plurality of magnetic gradient units has one current in an opposite direction through either the first wire loop or the second wire loop than the current direction in a neighboring magnetic field gradient unit; and
a magnetic gradient unit variation control unit, wherein the variation control unit varies the magnetic field gradient between adjacent magnetic gradient units producing a second magnetic field gradient about perpendicular to the magnetic field gradient produced by an individual magnetic gradient unit, and wherein the position of the second magnetic field gradient is varied by the variation control unit, and where variation of the position accelerates spin particles in the direction of the second magnetic field gradient.

18. A spin particle detection device comprising:
a first magnetic gradient region;
a second magnetic gradient region;
a uniform magnetic field region;
an oscillating magnetic field region;
a control circuit, wherein the control circuit sets an oscillating frequency for the oscillating magnetic field region, wherein the oscillating magnetic field is configured to change the spin orientation of at least one spin particle; and
a first detector, wherein the first detector is configured to detect the at least one spin particle if it had its spin orientation changed.

19. The spin particle detection device according to claim 18, further comprising:
a second detector, wherein the second detector is configured to detect any spin particles whose spin orientation were not changed by the oscillating magnetic field.
